(19) United States
(12) Patent Application Publication
(10) Pub. No.: US 2003/0074204 A1
(43) Pub. Date: Apr. 17, 2003

(54) Offline browsing

(76) Inventors: Prasad Krothapalli, San Jose, CA (US); Sanjay Dubey, Union City, CA (US); Dave Sulcer, Santa Clara, CA (US); Amitabh Sinha, Redwood City, CA (US); Rajiv Anand, Santa Clara, CA (US); Prakash Iyer, San Jose, CA (US); Rajeev Mohindra, Santa Clara, CA (US)

Correspondence Address: PILLSBURY WINTHROP LLP, Ninth Floor, East Tower, 1100 New York Avenue, N.W., Washington, DC, 20005-3918, US

(21) Appl. No.: 09/765,074

(22) Filed: Jan. 17, 2001

(51) Int. Cl. G06F 17/60

(52) U.S. Cl. 705/1

(57) ABSTRACT

A method for obtaining a service in an offline mode and later completing the service in an online mode. The method includes obtaining a service in an offline mode at a communications device, wherein the service would have required at least two transactions with a first server in an online mode. The method then includes associating with the service a pointer to a sequence of at least one operation to be performed at a first server, and sending in an online mode the pointer.

### FIELD

This invention relates to obtaining a service using a communication device, and more specifically, to providing a facility for initiating procurement of a service in an offline mode and later efficiently completing in an online mode procurement of the service.

### BACKGROUND

Increasingly, wireless communications devices such as cellular phones, personal digital assistants, handheld computers provide or are going to be required to provide services such as stock trading, buying or selling goods, and getting sports or flight information, among other services. At one time, these services could only be obtained if a communications link was available from the device to a wireless network that couples the device to a server that provides the desired service. Consequently, a user of a wireless device would sometimes be faced with the situation in which the user would like to obtain a service but is unable to because of the lack of a communications link. The lack of a link may be due to the user being outside of the service area of the communications provider's network, deep inside a building blocking the transmission and receipt of radio waves, or out of the range of a relay device that relays information received from the device to the communications provider's network.

Instead of forcing a user of the device to wait until a communications link is available to initiate procurement of a service, some communications devices allow a user to initiate procurement of the service even though a communications link is unavailable. Later, when a communications link becomes available, the communications device will automatically complete procurement of the service without further intervention from the user.

For example, a technician upon completion of a work-order may want to update the work-order request at the technician's company's server. If the technician is not within range of the wireless communications network that couples the technician's data entry device to the server, the work order request cannot be immediately updated. However, if the technician chooses to update the work-order, the data entry device retrieves from a cache in the device the forms that a technician would have had to complete, if the device had been within range of the network.

Before being able to update the work-order, the technician typically has to navigate past a few preliminary forms before getting to the work order form. For example, the data entry device may have to first retrieve from the cache a login form which requests the technician to enter user identification and password. The device then retrieves a menu form that offers different functions that the technician can invoke. If the technician invokes the work order update function, a work order form is displayed. The technician can fill in the fields in the work order form as appropriate. As the technician is navigating through the forms and entering data, the data entry device creates a sequence of the names or addresses of the forms retrieved and stores the entered data.

When the device is later within the range of the network, the device retrieves the sequence of the names or addresses (or other identifiers) of the forms retrieved from the case and engages in a transaction for each of the forms in the sequence. For example, the device updates the work order on the company's server by engaging in one transaction to retrieve the login form from the server, another transaction for the menu form, and yet another transaction for the work order form. Finally, a transaction is performed to update the work order using the data entered by the technician. Having the device engage in three transactions with the server to get the three forms is unnecessary because the device is not going to display the forms to the user. Rather the device will perform the three transactions with no interaction with the user. Furthermore, engaging in the three retrieval transactions is a waste of communications bandwidth and takes up unnecessary channel time that can be offered to other users besides the technician.

While the problem of wasted bandwidth and channel time was described in the context of a technician updating a work order, it should be appreciated that this problem is present in many contexts. For example, a user may have to navigate offline across multiple forms to arrive at a form that allows a stock trade to be performed.

Having the communication device engage in a transaction for each of the forms traversed offline by a user is a waste of communications bandwidth (or channel time). Present devices do not have the facility to conserve channel time and bandwidth. Consequently, it is desirable to provide a mechanism for allowing a communications device to complete online in an efficient manner a service that was obtained offline.

### SUMMARY

A method for obtaining a service in an offline mode and later completing the service in an online mode is described. The method includes obtaining a service in an offline mode at a communications device, wherein the service would have required at least two transactions with a first server in an online mode. The method then includes associating with the service a pointer to a sequence of at least one operation to be performed at a first server, and sending in an online mode the pointer.

### DESCRIPTION OF THE DRAWINGS

The present invention is illustrated by way of example, and not limitation, in the figures of the accompanying drawings in which like references denote similar elements, and in which:

FIG. 1 illustrates a block diagram of a system in which wireless and wired devices communicate with an application server;

FIG. 2 illustrates screen displays of documents associated with a stock trading service;

FIG. 3 illustrates a block diagram of a personal computer according to one embodiment of the present invention;

FIG. 4 illustrates a process for obtaining service in an offline mode;

FIG. 5 illustrates a process for completing a service in an online mode; and

FIG. 6 illustrates a block diagram of a server that allows efficient completion of a service that was procured in an offline mode.

### DETAILED DESCRIPTION

Methods and apparatus for obtaining a service in an offline mode and later completing the service in an online mode are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electromagnetic, electrical, magnetic or optical signals capable of being stored, transmitted, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

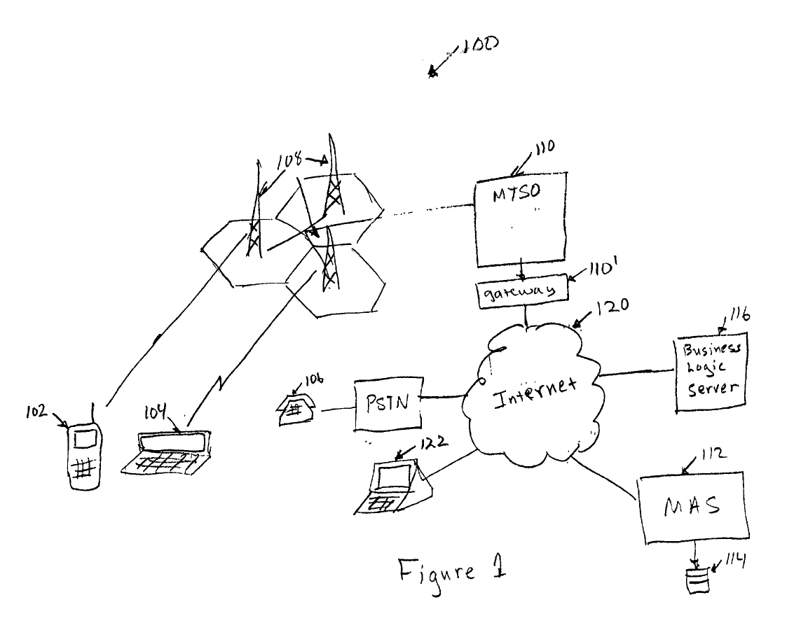

FIG. 1 illustrates a block diagram of a system in which wireless and wired devices communicate with an application server. System 100 includes telephone 102, pocket personal computer (PC) or personal digital assistant (PDA) 104, telephone 106, cellular stations 108, mobile telephone switching office 110, gateway 110′, public switched telephone network switching office 111, mobile application server 112, storage 114, business logic server 116, web server 118, internet 120, and computer 122. PDA 104 communicates with application server 112 by first setting up a data link with cellular station 108. Cellular station 108 relays to MTSO 110 data received from PDA 104. MTSO 110 in turn sends the data to gateway 110′. MTSO is an interface to the public switched telephone network for mobile phones making telephone calls to or receiving calls from telephones such as telephone 106. MTSO 110 directs internet traffic to and from gateway 110′ which is an interface between the wireless network and internet 120. Server 112 communicates with business logic server 116 which provides in various embodiments services including, but not limited to, retrieving stock quotes and airline flight information or sport scores, trading stock, buying and selling goods.

Business logic server 116 generates visual information such as documents providing product offerings, query pages for information such as flight or stock quotes, and pages for obtaining other services. The documents can be in hypertext markup language (HTML) or another page description language. The pages can be rendered on a screen of a device. In one embodiment, business logic server 116 is unable to communicate directly with PDA 104 because it generates HTML documents that cannot be rendered on the tiny screen of PDA 104. In one embodiment, PDA 104 renders documents in Palm hypertext markup language (Palm HTML). Server 112 has a software suite that permits the documents to be reformatted, reduced, or represented in a different manner Palm HTML such that the services indicated above can be provided despite the small screen of PDA 104. Using the appropriate Palm HTML code server 112 may provide only a portion of a document at a time on PDA 104. A user would navigate from one portion of the document to another by inputting a signal to change from one portion of the document to another, whether by pressing a key, touching an area of the screen, or by some other method. Furthermore, by the aforementioned methods, a user can respond to queries and choices sent from server 112 and server 116. Because PDA 104 is unable to render the documents generated by server 116, PDA 104 is referred to herein as a reduced content device.

The description below of the procurement of a service provided by servers 112 and 116 is provided in the context of PDA 104 obtaining the service. It should be appreciated that the description is equally applicable to other reduced content communications devices that have user input and output interfaces and the ability to communicate with a wireless network.

To obtain a service provided by server 116, a user using PDA 104 enters the uniform resource locator (URL) for the website providing the service to server 116 by way of stations 208 and MTSO 210. Since server 116 communicates using HTML, server 116 cannot communicate directly with PDA 104. Consequently, it informs PDA 104 that it should redirect its requests for service to server 112 by sending PDA 104 the URL for the website providing the service on server 112. Having server 116 redirect PDA 104 to server 112 is referred to herein as redirection. Redirection is the subject of co-pending application “Method And Apparatus For Using A Known Address To Gain Access To A Service Provider Having An Unknown Address” with Ser. No. ________ filed on Jan. 17, 2001. PDA 104 then sends the URL received from server 116 to MTSO 210 by way of stations 208. MTSO 210 then forwards the URL to server 112.

In one embodiment, server 112 recognizes from the URL that PDA 104 is requesting a document that is associated with a particular service provided by server 116. Consequently, server 112 requests that server 116 send to it the HTML document. Server 112 sends to PDA 104 a Palm HTML document based on the HTML document. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999. PDA 104 renders the Palm HTML document on its display. The screen rendered on the display may include fields that need to be filled in or links to other documents. Depending on the user's commands, another Palm HTML document may be retrieved from server 112, and another screen is rendered on the display of PDA 104. While in the above description server 112 responds to a request from PDA 104 by retrieving an HTML document from server 116, in an alternative embodiment server 112 responds with a Palm HTML document to PDA 104, without first retrieving an HTML document from server 116. In other words, server 112 may include the business logic necessary to provide the service without having to include server 116.

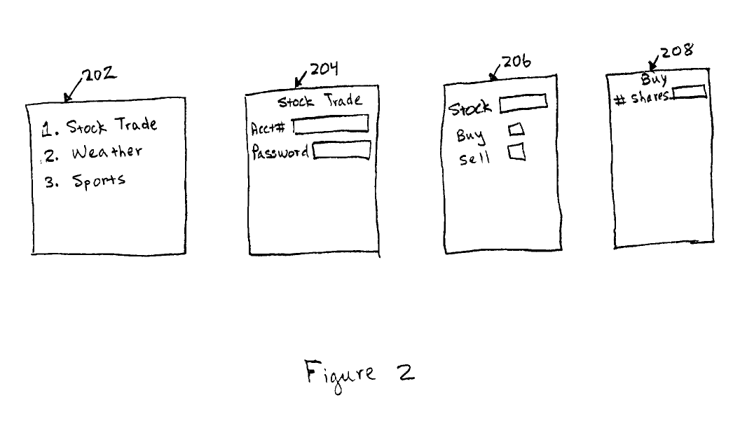

FIG. 2 illustrates screen displays of documents associated with a stock trading service. Screens 202-208 are an example of a sequence of screen displays that may be rendered on the display of PDA 104 as a user is trading a stock in an online mode. Each of the documents associated with the screens requires a transaction to be conducted between PDA 104 and server 112. A transaction includes a request from PDA 104 for a document and a response containing the document by server 112. For example, four transactions would be required to retrieve the documents that correspond to screens 202-208 and a fifth transaction to actually perform the stock trade.

While the above description was in the context of performing a stock trade, it should be appreciated that the description is equally valid for obtaining other services including, but not limited to, buying an item, sending an email message, getting stock quotes, and retrieving weather or sports information. Furthermore, the above is a description of a service (i.e., stock trade request) that is obtained when there is a communications link between PDA 104 and server 112.

Sometimes when there is no communications link between PDA 104 and server 112, it is desirable to give the user the appearance that there is a communications link between PDA 104 and server 112 and that a service can be obtained. Being able to ‘obtain’ service when there is no communications link (offline mode) enhances the user's sense of the quality of the service because it allows the user to initiate service when it is convenient for the user and not only when there is a communications link. Later, when a communications link is available (online mode), PDA 104 completes the service. Giving the user the appearance of a communications link that is always available and allowing the user to initiate a service is an important feature that adds to the desirability of a communications device such PDA 104.

PDA 104 provides several services that can be obtained in an offline mode, giving the appearance of communications link being available. For example, PDA 104 may allow a trade to be initiated or a form to be filled in in an offline mode. Later when there is a communications link the service can be completed. Completing the service refers to actually conducting the trade with a server that handles such trades or updating a form on a server that stores such forms. The appearance of a communications link happens because PDA 104 retrieves from storage (e.g., cache) screens associated with the service that a user desires to obtain.

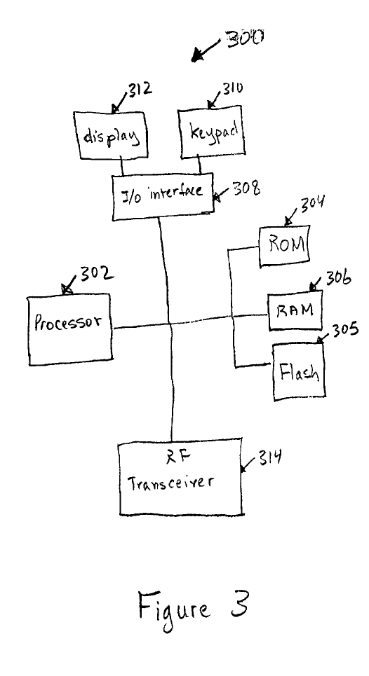

FIG. 3 illustrates a block diagram of a personal computer according to one embodiment of the present invention. PDA 104 includes processor 302, read only memory (ROM) 304, flash memory 305, random access memory (RAM) 306, user input/output interface 308, keyboard 310, display 312, and radio frequency transceiver 314. Processor 302 executes programming instructions in memory 304 and/or memory 306. The programming instructions result in a menu of services being displayed on display 312. Screen 202 is an example of a menu that PDA 104 shows on display 312. A user of PDA 104 selects using keyboard 310 a service from a list of services shown on display 312. Interface 308 provides the keyboard input to processor 302 which retrieves, depending on the keyboard input, from memory 305 a document and renders it on display 312 using interface 308 to create a screen of information. Assuming that the user of PDA 104 selected “stock trade” from screen 202, screen 204 will be shown to the user. The user can enter the information for account number and password and submit screen 204 which will cause processor 302 to render screen 206 on display 312. At screen 206, the user can then enter the information for stock symbol, and whether shares are to be bought or sold. Assuning the user selects to buy shares, after the user submits screen 206, processor 302 renders screen 208 on display 312 and the user is then able to enter the quantity of shares the user desires to buy. When the user submits screen 208, processor 302 stores in memory 305 the user information and a macro instruction that identifies the service that was obtained by the user. The user information is stored along with the variables with which the user information is associated. For example, assuming user enters 12345678 for account number a variable accountnumber is assigned the value 12345678. The other variables associated with the service are assigned the values entered by the user. In this example, the other variables are password, symbol (stock symbol), quantity (quantity of shares), and action (buy or sell shares). Memory 305 includes a macro instruction for each service which can be procured in an offline mode as described herein.

Processor 302 then checks to determine whether transceiver 314 can establish a communications link with stations 108. If a communications link can be established, processor 302 sends in the form of an HTTP request the user information and the macro instruction to server 112. The following is an example of an HTTP request associated with a trade service:

http://services.everypath.com/macroid=trade&accountnumber=12345678&password=KB4AUY&action=buy&quantity=10&symbol=ORCL

Macroid identifes the sequence of operations at server 112 that needs to execute using the information supplied by the user. The accountnumber is 12345678, and the password is KB4AUY. The trading action requested is the purchase (buy) of 10 shares of the stock with symbol ORCL.

If a communications link cannot be established, processor 302 periodically checks to see if a communications link can be established. When a link can be established, processor 302 sends the user information and the macro instruction to server 112 using an HTTP request as described above.

When server 112 receives the user information and the macro instruction it retrieves from storage 114 the sequence of operations that correspond to the macro instruction received in the request. Server 112 then executes each of the operations in the sequence using the variables defined in the HTTP request.

The following is an example of a sequence of operations for performing a trade:

| Macro | Trade |
|---|---|
| GET | opt=trading |
| POST | accountnumber=$(accountnumber)&password=$(password) |
| POST | action=$(action)&symbol=$(symbol) |
| POST | quantity=$(quantity) |

The $( ) indicates that the name to the left of the “=” symbol is a variable that needs to be defined. Since the HTTP request from PDA 104 to server 112 included definitions for user and password, the definitions are substituted for (accountnumber) and $(password), respectively when server 112 executes the post operation accountnumber=$(accountnumber)&password=$(password).

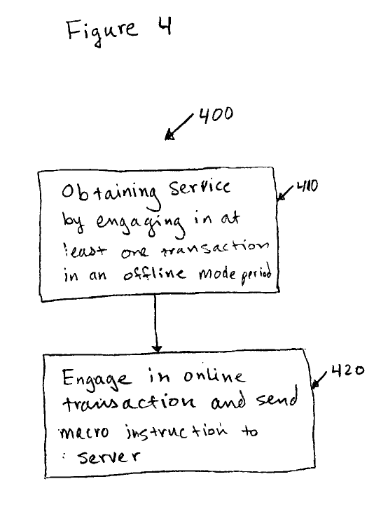

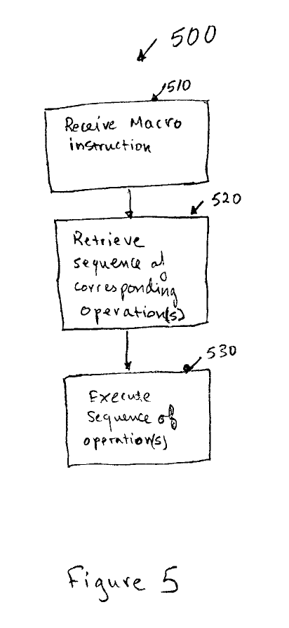

Server 112 executes the first operation of the macro instruction which is GET opt=trading. In one embodiment, server 112 engages in an HTTP request with server 112 to execute each operation in the macro instruction. In an alternative embodiment, server 112 executes the operations without engaging in an HTTP request with another server. The first operation retrieves the login screen from server 116. Server 112 uses the user information and password supplied by the user and engages in another HTTP request, POST accountnumber$(accountnumber)&password$(password), with server 116. The second operation retrieves the symbol identification and buy-sell menu page from server 116. Server 112 then executes the third operation, POST action=$(action)&symbol=$(symbol), which indicates that the user wants to buy shares of ORCL. The third action retrieves the quantity screen from server 116. Server 112 then executes the fourth operation, POST quantity=S(quantity) using a quantity of 10 to complete the stock purchase transaction. While server 112 engaged in four operations to complete the stock purchase transaction, PDA 104 and server 112 only had to engage in one HTTP request to effectuate the stock purchase transaction. This results in savings of bandwidth and communication time. PDA 104, server 112, and server 116 as just described operate in one embodiment in accordance with process 400 and process 500 described below in connection with FIG. 4, and FIG. 5, respectively.

FIG. 4 illustrates a process for obtaining service in an offline mode in an embodiment according to the present invention. In process 400, PDA 104 or other communications device allows a user to procure 410 a service in an offline mode. In one embodiment, procuring the service may involve retrieving several screens of information from memory, displaying the screens on PDA 104, and allowing the user to enter information in order to define variables needed to complete the service later without further user intervention. After service is procured in an offline mode, PDA 104 engages 420 in an online transaction which sends to server 112 any user supplied information and a macro instruction indicative of the service procured by the user. The macro instruction is a pointer to operations that server 112 executes in order to complete the service procured in an offline mode by the user.

FIG. 5 illustrates a process for completing a service in an online mode in an embodiment according to the present invention. In process 500, server 112 receives 510 user supplied information and a macro instruction indicative of a service procured in an offline mode by a user. Based on the macro instruction, server 112 retrieves 520 from storage 114 a sequence of at least one operation. Using the user supplied information, server 112 executes 530 each operation in order to complete the service procured in an offline mode by the user. In one embodiment, server 112 engages in an HTTP request with server 116 for each operation in the sequence. Server 112 engages in an HTTP request because server 116 implements the business logic necessary to complete the service. In an alternative embodiment, server 112 is able to complete the service without engaging in an HTTP request with another server because server 112 includes the business logic necessary to complete the service.

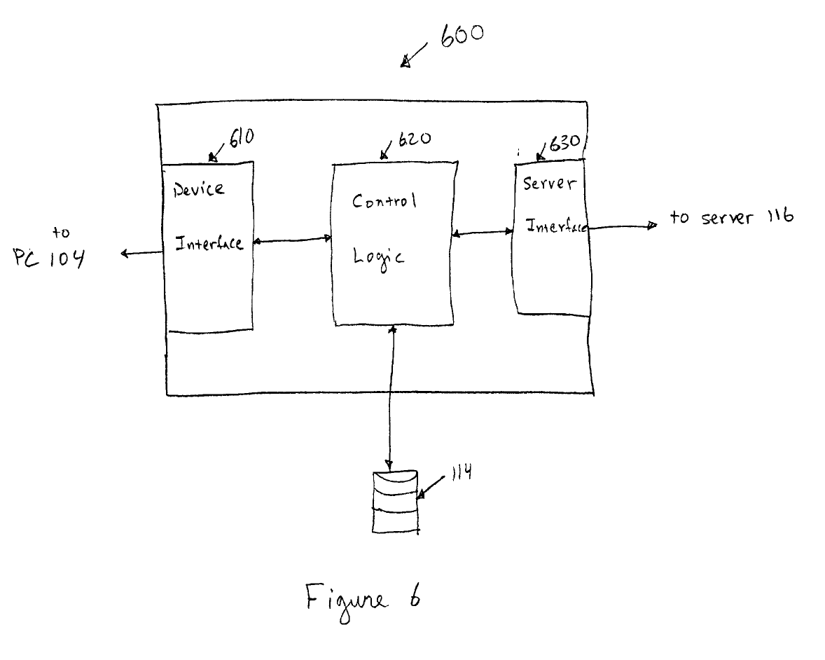

FIG. 6 illustrates a block diagram of a server that allows efficient completion of a service that was procured in an offline mode according to one embodiment of the present invention. Server 600 is representative of server 112 of FIG. 1. In one embodiment, server 600 includes device interface 610 that is to receive an HTTP request from gateway 110′. The HTTP request was received by gateway 110′ from PDA 104. The HTTP request which included the macroid=trade, described above, is an example of an HTTP request that is received by interface 610. When interface 610 receives an HTTP request including a macro instruction, control logic 620 looks up in storage 114 the sequence of operations that correspond to the macro instruction received in the request. Control logic 620 then executes each of the operations in the sequence. The macro “Trade” defined above is an example of a sequence of operations that control logic 620 executes. According to one embodiment, control logic 620 engages in a transaction or HTTP request with server 116 for each of the operations it executes, using server interface 630. Logic 620 engages in transactions with server 116 because server 116 implements the business logic needed to complete the service. In alternative embodiment, control logic 112 does not need to engage in a transaction with another server to execute the operation. In the embodiment just described, server 600 operates in accordance with process 500 described above in connection with FIG. 5.

Thus, methods and apparatus for obtaining a service in an offline mode and later completing the service in an online mode are described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for obtaining a service in an offline mode and later completing the service in an online mode, the method comprising:
obtaining a service in an offline mode at a communications device;
associating with the service a pointer to a sequence of at least one operation to be performed at a first server; and
sending in an online mode the pointer.

2. The method of claim 1, further comprising sending in an online mode information entered in obtaining the service.

3. The method of claim 1, further comprising:
retrieving the sequence from storage; and
executing the sequence of operations to complete the service without further engaging the first device.

4. The method of claim 2, further comprising:
retrieving the sequence from storage; and
executing the sequence using the information to complete the service without further engaging the first device.

5. The method of claim 1, wherein the sequence of at least one operation is a sequence of at least one HTTP request.

6. A method for obtaining a service in an offline mode and later completing the service in an online mode, the method comprising:
receiving at a first server from a communications device a pointer to a sequence of at least one operation;
wherein the pointer is indicative of a service procured in an offline mode at the device.
retrieving the sequence of at least one operation; and
executing the sequence of at least one operation without further engaging the communications device.

7. The method of claim 6, wherein the sequence of at least one operation is a sequence of at least one HTTP request.

8. The method of claim 6, wherein executing the sequence includes engaging in a transaction with a second server for each operation in the sequence.

9. The method of claim 6, further comprising receiving information entered by a user in procuring the service.

10. The method of claim 9, wherein executing the sequence includes executing the sequence using the information entered by the user in procuring the service.

11. A communication device, the device comprising:
a user interface that is to present information to a user and to receive input from the user;
control logic that is present the information to the user and to process the input to allow the user to procure a service in an offline mode;
storage that is to store based on a command from the control logic a pointer indicative of the service procured by the user;
wherein the pointer points to a sequence of at least one operation to be performed at a first server to complete procurement of the service; and
transceiver that is to retrieve the pointer from storage and send the pointer to a first server when the transceiver is able to establish an online connection to the first server.

12. The device of claim 11, wherein the pointer is to a sequence of at least one HTTP request.

13. A server that allows a communications device to efficiently complete a service procured in an offline mode at the device, the server comprising:
a device interface that is to receive from a communications device a pointer that points to a sequence of at least one operation;
wherein the pointer is indicative of a service procured by a user in an offline mode at the device; and
control logic that is to retrieve based on the pointer the sequence of at least one operation and to execute the sequence.

14. The server of claim 13, wherein the sequence of at least one operation is a sequence of at least one HTTP request.

15. The server of claim 14, wherein the device interface is to also receive information entered by the user in procuring the service.

16. The server of claim 15, wherein the control logic is to execute the sequence using the information.
